(19) United States
(12) Patent Application Publication
(10) Pub. No.: US 2026/0126760 A1
(43) Pub. Date: May 7, 2026

(54) METHOD FOR RECOMMENDING SETTING OF SCREEN AND ELECTRONIC DEVICE SUPPORTING THEREOF

(71) Applicant: Samsung Electronics Co., Ltd., Suwon-si (KR)

(72) Inventors: Yongki PARK, Suwon-si (KR); Yeojin KIM, Suwon-si (KR); Hana LEE, Suwon-si (KR); Yonggil HAN, Suwon-si (KR); Woojung HAN, Suwon-si (KR)

(21) Appl. No.: 19/440,176

(22) Filed: Jan. 5, 2026

Related U.S. Application Data
(63) Continuation of application No. PCT/KR2024/010189, filed on Jul. 16, 2024.

(30) Foreign Application Priority Data
Jul. 17, 2023 (KR) 10-2023-0092635
Sep. 21, 2023 (KR) 10-2023-0126576

(51) Int. Cl. G04G 21/00; G06F 3/0484

(52) U.S. Cl. CPC G04G 21/00; G06F 3/0484

(57) ABSTRACT

An electronic device may include: a display, a communication circuit, a memory, and a processor functionally connected, directly or indirectly, to the display, the communication circuit, and the memory. The processor(s) may be configured to: acquire setting information related to at least one first screen of an external electronic device; identify at least one second object, corresponding to at least one first object constituting the at least one first screen, in the memory on the basis of the setting information; and/or use the at least one second object to recommend a setting of a second screen displayed on the display. Various other embodiments understood through the present document are also possible.

### CROSS-REFERENCE TO RELATED APPLICATIONS

This application is a continuation application of International Application No. PCT/KR2024/010189, filed on Jul. 16, 2024, in the Korean Intellectual Property Receiving Office, and claiming priority to KR Application No. 10-2023-0092635 filed Jul. 17, 2023, and KR Application No. 10-2023-0126576 filed Sep. 21, 2023, the disclosures of which are all hereby incorporated by reference herein in their entireties.

### TECHNICAL FIELD

Various example embodiments may relate to a method for recommending a setting of a screen and/or an electronic device supporting thereof.

### BACKGROUND ART

Recently, wearable electronic devices like smart watches are being increasingly used. Wearable electronic devices have the advantages of mobility and portability since they are wearable on parts of users' bodies. Such wearable electronic devices may provide the same or similar functions as or to those of electronic devices like smart phones. For example, wearable electronic devices may display watch screens and may support execution of various applications.

### SUMMARY

An electronic device according to various example embodiments may include: a display; a communication circuit; a memory configured to store instructions; and at least one processor comprising a processing circuit, and, when individually or collectively executed by the at least one processor, the instructions may cause the electronic device to: acquire setting information related to at least one first screen of an external electronic device; identify at least one second object corresponding to at least one first object constituting the at least one first screen from the memory, based on the setting information; and recommend a setting of a second screen displayed on the display by using the at least one second object.

A method for recommending a setting of a screen according to various example embodiments may include: acquiring setting information related to at least one first screen of an external electronic device; identifying at least one second object corresponding to at least one first object constituting the at least one first screen from a memory, based on the setting information; and recommending a setting of a second screen displayed on a display by using the at least one second object.

In certain example embodiments, there may be provided a computer-readable recording medium for executing a method which may include: acquiring setting information related to at least one first screen of an external electronic device; identifying at least one second object corresponding to at least one first object constituting the at least one first screen from a memory, based on the setting information; and recommending a setting of a second screen displayed on a display by using the at least one second object.

### DESCRIPTION OF DRAWINGS

FIG. 1 is a block diagram of an electronic device in a network environment according to various example embodiments.

FIG. 2 is a view provided to explain a configuration of an electronic device which recommends a setting of a screen according to an example embodiment.

FIG. 3 is a view provided to explain a method for recommending a setting of a screen according to an example embodiment.

FIG. 4 is a view provided to explain a method for processing setting information of a watch screen according to an example embodiment.

FIG. 5 is a view provided to explain a method for processing setting information of an object related to an application according to an example embodiment.

FIG. 6 is a view provided to explain a screen related to setting information acquired from an external electronic device according to an example embodiment.

FIG. 7 is a view provided to explain a screen which is recommended in an electronic device according to an example embodiment.

FIG. 8 is a view provided to explain a method for recommending a setting of a screen, based on a watch screen list according to an example embodiment.

FIG. 9 is a view provided to explain a method for recommending a setting of a screen based on a watch screen list according to an example embodiment.

FIG. 10 is a view provided to explain a method for setting a priority according to a type of an object related to an application according to an example embodiment.

FIG. 11 is a view provided to explain a method for recommending a setting of a screen based on setting information of a watch screen and setting information of an object related to an application according to an example embodiment.

FIG. 12 is a view provided to explain a method for recommending a setting of a screen based on color information according to an example embodiment.

FIG. 13 is a view provided to explain an example of change of a second screen displayed on an electronic device to another second screen when a first screen displayed on an external electronic device is changed to another first screen according to an embodiment.

FIG. 14 is a view provided to explain an example of change of a configuration of a second screen displayed on an electronic device when a complication is added within a first screen displayed on an external electronic device according to an embodiment.

FIG. 15 is a view illustrating an example of a second screen that is set to be visually similar to a first screen displayed on an external electronic device and is displayed on an electronic device.

Regarding the explanation of drawings, the same or similar reference numerals may be used for the same or similar components.

### DETAILED DESCRIPTION

Hereinafter, various embodiments will be described with reference to the accompanying drawings. For the convenience of explanation, components illustrated in the drawings may be exaggerated or reduced in their sizes, and the disclosure is not necessarily limited by those illustrated in the drawings.

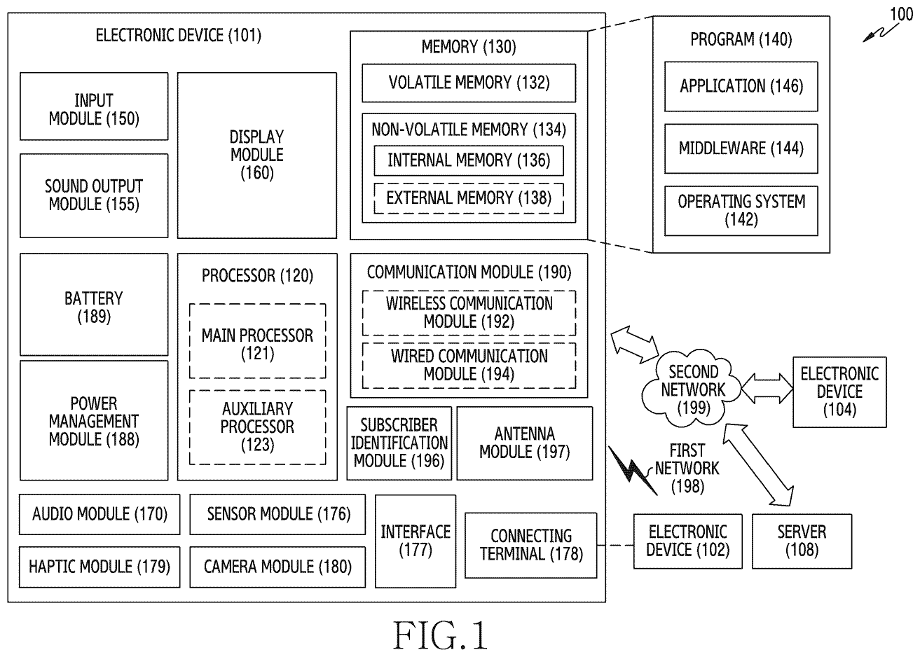

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled, directly or indirectly, with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, each “processor” herein may comprise processing circuitry.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192, comprising communication circuitry) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

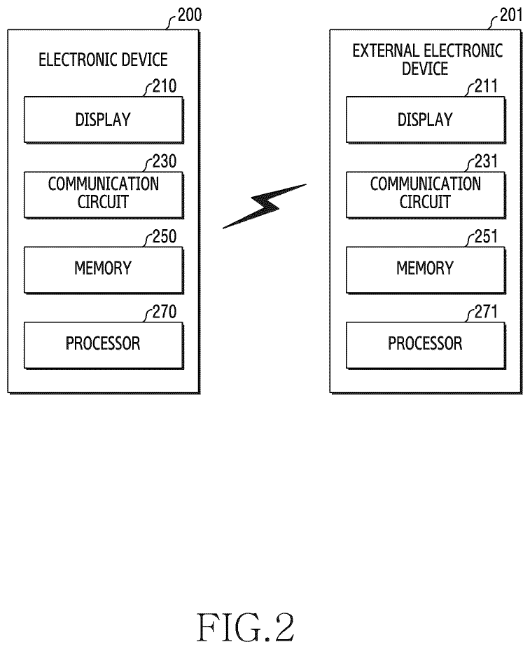

FIG. 2 is a view provided to explain configurations of an electronic device and an external electronic device which recommend a setting of a screen according to an embodiment.

Referring to FIG. 2, the electronic device 200 (for example, the electronic device 101 of FIG. 1) may include a display 210 (for example, the display module 160 of FIG. 1), a communication circuit 230 (for example, the communication module 190 of FIG. 1, comprising communication circuitry), a memory 250 (for example, the memory 130 of FIG. 1), and a processor 270 (for example, the processor 120 of FIG. 1, comprising processing circuitry). However, the configuration of the electronic device 200 is not limited thereto. According to various embodiments, the electronic device 200 may omit at least one of the above-described components or may further include at least one other component.

The display 210 may display various contents (for example, a text, an image, a video, an icon or a symbol) for a user. The display 210 may include a touch screen, and for example, may receive at least one of a touch, a gesture, approach or a hovering input using an electronic pen or a part of user's body. According to an embodiment, the display 210 may display at least one object that recommends a setting of a screen.

The communication circuit 230 may support communication between the electronic device 200 and an external electronic device. For example, the communication circuit 230 may establish wired communication or wireless communication according to a communication protocol prescribed with the external electronic device, and may exchange signals or data.

The memory 250 may store various data that is used by at least one component of the electronic device 200. According to an embodiment, the memory 250 may store instructions and data for recommending a setting of a screen. In this case, the instructions may be executed by the processor 270.

The processor 270 may control at least one component of the electronic device 200, and may perform a variety of data processing or computation. According to an embodiment, the processor 270 may perform a function for recommending a setting of a screen by executing instructions stored in the memory 250 included in the electronic device 200.

Referring to FIG. 2, an external electronic device 201 (for example, the electronic device 102, 104 of FIG. 1) may include a display 211, a communication circuit 231, a memory 251, and a processor 271. However, the configuration of the electronic device 201 is not limited thereto. According to various embodiments, the electronic device 201 may omit at least one of the above-described components or may further include at least one other component.

The display 211 may display various contents (for example, a text, an image, a video, an icon or a symbol) for a user. The display 211 may include a touch screen, and for example, may receive at least one of a touch, a gesture, approach, or a hovering input using an electronic pen or a part of user's body. According to an embodiment, the display 211 may display at least one object that recommends a setting of a screen.

The communication circuit 231 may support communication between the external electronic device 201 and an electronic device. For example, the communication circuit 231 may establish wired communication or wireless communication according to a communication protocol prescribed with the external electronic device 201, and may exchange signals or data.

The memory 251 may store various data that is used by at least one component of the external electronic device 201. According to an embodiment, the memory 251 may store instructions or data for recommending a setting of a screen. In this case, the instructions may be executed by the processor 271.

The processor 271 may control at least one component of the external electronic device 201, and may perform a variety of data processing or computation. According to an embodiment, the processor 271 may perform a function for recommending a setting of a screen by executing instructions stored in the memory 251 included in the external electronic device 201.

According to an embodiment, the processor 270 may acquire setting information related to at least one first screen of an external electronic device from the external electronic device (for example, the electronic device 102, 104) connected through the communication circuit 230. Here or in the following descriptions, acquiring setting information may be understood as (or substituted with) detecting, recognizing, determining, sensing or identifying setting information. According to an embodiment, the at least one first screen may include a screen of a wearable electronic device (for example, a smart watch). According to an embodiment, the at least one first screen may include at least one of a watch screen (or a watchface) including a complication or a tile including a widget of an application. The complication, which is an additional information element displayed on the watch screen, may be an object (for example, an icon, a visual object, an image, a widget or an affordance) that executes at least one function of an application. The complication may provide, for example, information such as the number of steps, alarm, weather, social network service (SNS) or sleep. According to an embodiment, the complication may be displayed in a designated area of the watch screen. The tile may include an execution screen of a widget of an application. The tile may include a plurality of tiles like pages, and each tile may constitute one screen. In this case, based on a user input (for example, a swipe input), transition between tiles, for example, screen transition from a first tile to a second tile, may be performed.

According to an embodiment, the setting information may include at least one of history information of the watch screen displayed on the at least one first screen, object information related to an application displayed on the at least one first screen, or color information used for the at least one first screen. The history information of the watch screen may be information related to a display history of the watch screen displayed on the at least one first screen. The object information related to the application may include an icon, a visual object, an image, a widget or an affordance related to the application.

The processor 270 may identify at least one second object corresponding to at least one first object constituting the at least one first screen in the memory 250, based on the setting information. The at least one first object may be an object that is installed (or stored) in the external electronic device, and may include at least one of the watch screen, a complication included in the watch screen, the tile or a widget included in the tile.

The at least one second object may be an object that is installed (or stored or set) in the electronic device 200, and may include at least one of a watch screen or a widget of an application. The at least one second object may be an object corresponding to a widget that is not installed (or stored or set) in the electronic device.

The processor 270 may recommend a setting of a second screen displayed on the display 210 by using the at least one second object. Here or in the following descriptions, recommending a setting of the second screen may be understood as (or substituted with) offering, proffering, proposing, or suggesting a setting of the second screen. The second screen may be a screen that is displayed on the display 210. According to an embodiment, the electronic device 200 may include a housing including a first part and a second part, a flexible display seated on, directly or indirectly, a first surface of the first part and a second surface of the second part, and a hinge structure which pivots the first part or the second part to go into a first state in which the first surface and the second surface are substantially coplanar, or a second state in which the first surface and the second surface face each other. For example, the electronic device 200 may be a foldable electronic device. When the electronic device 200 is a foldable electronic device, the second screen may be a screen that is displayed on a cover display. For example, the display 210 may include a cover display, and the second screen may be displayed on the display 210 disposed on a third surface of the first part that faces a direction opposite to the direction that the first surface of the first part faces.

According to an embodiment, the processor 270 may determine at least one first watch screen as the first object, based on the history information of the displayed watch screen, may acquire at least one second watch screen corresponding to the at least one first watch screen as the second object from the memory 250, and may recommend the at least one second watch screen for the second screen. The history information of the displayed watch screen may include, for example, at least one of the number of times or the frequency that the at least one first watch screen is used, or an order (or an arrangement order) in which the at least one first watch screen is disposed in a first list (for example, a watchface list) including a plurality of watch screens. For example, the processor 270 may determine, as the at least one first watch screen, a watch screen that is much used or frequently used and/or a watch screen that is disposed at the front of the first list including the plurality of watch screens. According to an embodiment, the processor 270 may determine the at least one first watch screen based on a list of widgets displayable on the display 210. For example, the processor 270 may identify an application corresponding to a widget included in the list of widgets displayable on the display 210, and may determine a watch screen corresponding to the identified application as the first watch screen. In addition, the processor 270 may acquire a watch screen corresponding to the at least one determined first watch screen from the memory 250, and may determine the watch screen acquired from the memory 250 as the at least one second watch screen.

According to an embodiment, the processor 270 may determine a display order of the at least one second watch screen in a second list, based on the history information of the displayed watch screen. For example, the processor 270 may determine the display order of the at least one second watch screen in the second list, based on at least one of the number of times or the frequency that the at least one first watch screen is used, or the order (or arrangement order) in which the at least one first watch screen is disposed in the list including the plurality of watch screens. According to an embodiment, the processor 270 may set a high priority (first priority) to a watch screen that is much used or frequently used and/or a watch screen that is disposed at the front of the list including the plurality of watch screens, and may display the watch screen. For example, the processor 270 may display the watch screen that is much used or frequency used and/or the watch screen that is disposed at the front of the list including the plurality of watch screens at a high position of the second screen. According to an embodiment, the processor 270 may determine the display order of the at least one second watch screen in the second list, based on the list of widgets displayable on the display 210. For example, the processor 270 may identify an application corresponding to a widget included in the list of widgets displayable on the display 210, and may set a high priority to a second watch screen corresponding to the identified application. Here or in the following descriptions, displaying on the second screen may be understood as (or substituted with) disposing, providing, presenting, representing, reproducing or rendering on the second screen.

According to an embodiment, the first priority may be set by following Equation 1:

$$W 1 = k 1 \times n 1 \times t 1 \qquad Equation 1$$

where W1 denotes a first priority, k1 denotes a configuration similarity of a watch screen, n1 denotes an opposite value of the disposition order (or arrangement order) in a list including a plurality of watch screens (for example, out of the total of 10, 10 for the first position, 9 for the second position, . . . , 1 for the 10^{th} position), and t1 denotes a use time. The configuration similarity may be assessed based on at least one of a background pattern, a texture, a character, a watch type (for example, digital or analogue), an amount of information provided except for time. The use time may indicate a time that is spent for a designated period (for example, last one month).

According to an embodiment, the processor 270 may determine at least one first application as the first object, based on the object information related to the application, may identify at least one second application installed in the electronic device 200 and corresponding to the at least one first application, and may recommend an object related to the at least one second application for the second screen as the second object. For example, the processor 270 may determine an application that is set as a complication and/or an application that is added to a list of tiles as the at least one first application. In addition, the processor 270 may identify whether an application corresponding to the at least one determined first application is installed in the electronic device 200, and may determine the identified application as the at least one second application.

According to an embodiment, the processor 270 may determine a display order of an object related to the at least one second application in the list, based on at least one of a type of an object related to the at least one first application, a proportion of the at least one first screen occupied by the object related to the first application, or the number of times or frequency that the object related to the first application is used. The type of the object may include, for example, a type of the complication. The type of the complication may include a line shape, a circle shape, an arc shape, or a rectangle shape. The complication may have different amounts of information displayed on the screen according to the type. For example, the complication of the rectangle shape may include more amounts of information than the complication of the line shape. According to an embodiment, the processor 270 may set a higher priority (second priority) to the type of the complication that displays more information. For example, the processor 270 may display an object at a high position of the second screen as the type of the object displays more information on the screen or the object is much used or frequently used.

According to an embodiment, the second priority may be set by following Equation 2:

$$W 2 = k 2 \times w \times n 2 \qquad Equation 2$$

where W2 denotes a second priority, k2 denotes a configuration similarity of a complication and a widget of the electronic device 200, w denotes an importance of a type of a complication, and n2 denotes the total number of times that a watch screen is used. The importance of the type of the complication may be higher as the complication includes more information.

According to an embodiment, a third priority related to an application added to the list of tiles may be set by following Equation 3:

$$W 3 = n 3 \times t 3 \qquad Equation 3$$

where W3 denotes a third priority, n3 denotes an opposite value of a disposition order (or arrangement order) in the list of tiles (for example, out of the total of 10, 10 for the first position, 9 for the second position, . . . , 1 for the 10^{th} position), and t3 denotes the number of times that a tile is used. The number of times that a tile is used may indicate the number of times that the tile is used for a designated period (for example, last 1 month).

According to an embodiment, a fourth priority related to an application that is set as the complication or added to the list of tiles may be set by following Equation 4:

$$W 4 = W 2 + W 3 \qquad Equation 4$$

where W4 denotes a fourth priority, W2 denotes a second priority, and W3 denotes a third priority.

According to an embodiment, the processor 270 may determine at least one color based on color information, and may display a color list including the at least one color on the second screen. The processor 270 may determine a display order of the at least one color, based on the number of times or the frequency that the at least one color is used.

As described above, according to various embodiments, the electronic device 200 may include the display 210, the communication circuit 230, the memory 250, and the processor 270 which is functionally connected, directly or indirectly, with the display, the communication circuit, and the memory.

According to various embodiments, the processor may acquire setting information related to at least one first screen of an external electronic device.

According to various embodiments, the processor may identify at least one second object corresponding to at least one first object constituting the at least one first screen from the memory, based on the setting information.

According to various embodiments, the processor may recommend a setting of a second screen displayed on the display by using the at least one second object.

According to various embodiments, the setting information may include at least one of history information of a watch screen displayed on the at least one first screen, object information related to an application displayed on the at least one first screen, or color information used for the at least one first screen.

According to various embodiments, the processor may determine at least one first watch screen as the first object, based on the history information of the watch screen, may acquire at least one second watch screen corresponding to the at least one first watch screen from the memory as the second object, and may recommend the at least one second watch screen for the second screen.

According to various embodiments, the processor may determine a display order of the at least one second watch screen within a second list, based on at least one of the number of times or frequency that the at least one first watch screen is used, or an order in which the at least one first watch screen is disposed in a first list including a plurality of watch screens.

According to various embodiments, the processor may determine at least one first application as the first object, based on the object information related to the application, may identify at least one second application installed in the electronic device and corresponding to the at least one first application as the second object and; and may display an object related to the at least one second application on the second screen.

According to various embodiments, the processor may determine a display order of the object related to the at least one second application within a list, based on at least one of a type of an object related to the at least one first application, a proportion of the at least one first screen occupied by the object related to the first application, or the number of times or frequency that the object related to the first application is used.

According to various embodiments, the processor may determine at least one color based on the color information, and may recommend a color list including the at least one color for the second screen.

According to various embodiments, the processor may determine a display order of the at least one color in a list, based on the number of times or frequency that the at least one color is used.

According to various embodiments, the at least one first screen may include at least one of a watch screen including a complication or a tile including a widget of an application.

According to various embodiments, the electronic device may further include: a housing including a first part and a second part; a flexible display seated on, directly or indirectly, a first surface of the first part and a second surface of the second part; and a hinge structure which pivots the first part or the second part to go into a first state in which the first surface and the second surface are substantially coplanar, or a second state in which the first surface and the second surface face each other.

According to various embodiments, the second screen may be displayed on the display that is disposed on a third surface of the first part opposite to the first surface.

According to various embodiments, the first object may include at least one of a watch screen, a complication included in the watch screen, a tile, or a widget included in the tile, which constitute the first screen.

According to various embodiments, the second object may include at least one of a watch screen or a widget of an application which constitute the second screen.

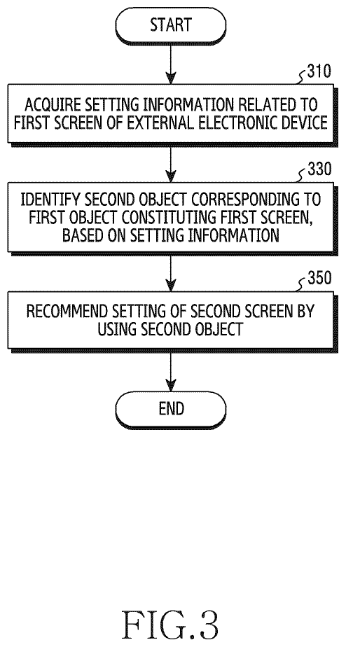

FIG. 3 is a view provided to explain a method for recommending a setting of a screen according to an embodiment.

Referring to FIG. 3, in operation 310, a processor (for example, the processor 270 of FIG. 2) of an electronic device (for example, the electronic device 200 of FIG. 2) may acquire setting information related to at least one first screen of an external electronic device from the external electronic device (for example, the electronic device 102, 104 of FIG. 1) connected via a communication circuit (for example, the communication circuit 230 of FIG. 2). According to an embodiment, the at least one first screen may include a screen of a wearable electronic device (for example, a smart watch). According to an embodiment, the at least one first screen may include at least one of a watch screen (or a watchface) including a complication or a tile including a widget of an application.

According to an embodiment, the setting information may include at least one of history information of a watch screen displayed on the at least one first screen, object information related to an application displayed on the at least one first screen, or color information used for the at least one first screen. The object information related to the application may include an icon, a visual object, an image, a widget or affordance related to the application.

In operation 330, the processor may identify at least one second object corresponding to at least one first object constituting the at least one first screen from a memory (for example, the memory 250 of FIG. 2), based on the setting information. The at least one first object may be an object that is installed (or stored or set) in the external electronic device, and may include at least one of a watch screen, a complication included in the watch screen, a tile, or a widget included in the tile. The at least one second object may be an object that is installed (or stored or set) in the electronic device, and may include at least one of a watch screen or a widget of an application. The at least one second object may be an object (for example, a widget) corresponding to an application that is not installed (or stored or set) in the electronic device. In this case, the electronic device may display a GUI for installing (or storing or setting) a second object (for example, a widget) in the electronic device when recommending a setting of the second screen including the second object (for example, a widget) corresponding to the first object.

In operation 350, the processor may recommend a setting of the second screen displayed on a display (for example, the display 210 of FIG. 2) by using the at least one second object. The second screen may be a screen that is displayed on the display. According to an embodiment, the electronic device may be a foldable electronic device. When the electronic device is a foldable electronic device, the second screen may be a screen that is displayed on a cover display.

According to an embodiment, the processor may determine a first watch screen as the at least one first object, based on the history information of the displayed watch screen, may acquire at least one second watch screen corresponding to the at least one first watch screen as the second object from the memory, and may recommend the at least one second watch screen for the second screen. The history information of the displayed watch screen may include, for example, at least one of the number of times or the frequency that the at least one first watch screen is used, or an order (or an arrangement order) in which the at least one first watch screen is disposed in a list (for example, a watchface list) including a plurality of watch screens. For example, the processor may determine, as the at least one first watch screen, a watch screen that is much used or frequently used and/or a watch screen that is disposed at the front of the first list including the plurality of watch screens. In addition, the processor may acquire a watch screen corresponding to the at least one determined first watch screen from the memory, and may determine the watch screen acquired from the memory as the at least one second watch screen. When the second watch screen is a watch screen that is not installed in the electronic device, the electronic device may display a GUI including a menu for installing the second watch screen.

According to an embodiment, the processor may determine a display order of the at least one second watch screen in a second list, based on the history information of the displayed watch screen. For example, the processor may determine the display order of the at least one second watch screen in the second list, based on at least one of the number of times or the frequency that the at least one first watch screen is used, or the order (or arrangement order) in which the at least one first watch screen is disposed in the first list including the plurality of watch screens. According to an embodiment, the processor may set a high priority to a watch screen that is much used or frequently used and/or a watch screen that is disposed at the front of the list including the plurality of watch screens, and may display the watch screen. For example, the processor may display the watch screen that is much used or frequency used and/or the watch screen that is disposed at the front of the list including the plurality of watch screens at a high position of the second screen.

According to an embodiment, the processor may determine at least one first application as the first object, based on the object information related to the application, may identify at least one second application installed in the electronic device and corresponding to the at least one first application as the second object, and may recommend an object related to the at least one second application for the second screen. For example, the processor may determine an application that is set as a complication and/or an application that is added to a list of tiles to be the at least one first application as the first object. In addition, the processor may identify whether an application corresponding to the at least one determined first application is installed in the electronic device, and may determine the identified application to be the at least one second application as the second object.

According to an embodiment, the processor may determine a display order of an object related to the at least one second application in the list, based on at least one of a type of an object related to the at least one first application, a proportion of the at least one first screen occupied by the object, or the number of times or frequency that the object is used. The type of the object may include, for example, a type of the complication. The complication may have different amounts of information displayed on the screen according to the type. According to an embodiment, the processor may set a higher priority to the type of the complication that displays more information. For example, the processor may display an object at a high position of the second screen as the type of the object displays more information on the screen or the object is much used or frequently used.

According to an embodiment, the processor may determine at least one color based on color information, and may display a color list including the at least one color on the second screen. The processor may determine a display order of the at least one color, based on the number of times or the frequency that the at least one color is used.

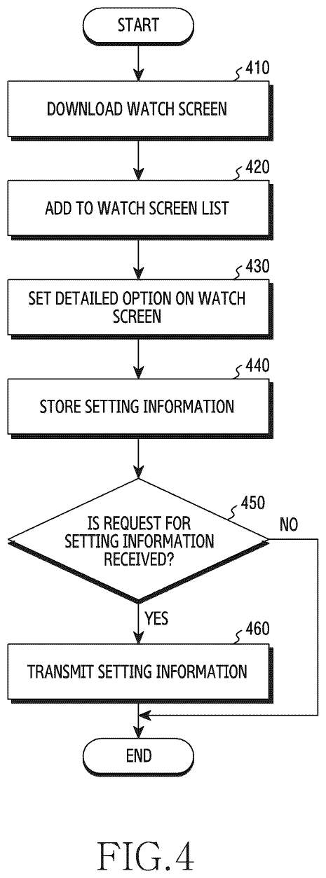

FIG. 4 is a view provided to explain a method for processing setting information of a watch screen according to an embodiment.

Referring to FIG. 4, a processor (for example, the processor 271 of FIG. 2) of an external electronic device (for example, the external electronic device 201 of FIG. 2) may provide setting information of a detailed option on a watch screen of the external electronic device to an electronic device (for example, the electronic device 200 of FIG. 2).

In operation 410, the processor of the external electronic device may download a watch screen. For example, the processor may download the watch screen from an external server (for example, the server 108 of FIG. 1) connected via a communication circuit (for example, the communication circuit 231 of FIG. 2).

In operation 420, the processor may add the downloaded new watch screen to a watch screen list. The downloaded watch screen may be a watch screen that is displayable on a display (for example, the display 211 of FIG. 2) of the external electronic device (for example, the electronic device 201 of FIG. 2). The watch screen list may be, for example, a list including a plurality of watch screens (for example, a watchface list). In some embodiments, the watch screen list may be a list of watch screens that is set as a bookmark.

In operation 430, the processor may set a detailed option for the watch screen. For example, the processor may set at least one of a background pattern, a texture, a character, a watch type (for example, digital or analogue), or a complication of the watch screen, based on a user input.

In operation 440, the processor may store setting information of the detailed option for the watch screen in a memory (for example, the memory 251 of FIG. 2).

In operation 450, the processor may determine whether a request for the setting information is received from the electronic device (for example, the electronic device 101 of FIG. 1) connected via at least the communication circuit.

When the request for the setting information is not received (No in operation 450), the processor may finish the process of processing the setting information of the watch screen.

When the request for the setting information is received (Yes in operation 450), the processor may transmit the setting information to the electronic device via the communication circuit in operation 460. The electronic device which receives the setting information may display an object that recommends a setting of a screen to be displayed on the display of the electronic device, based on the setting information.

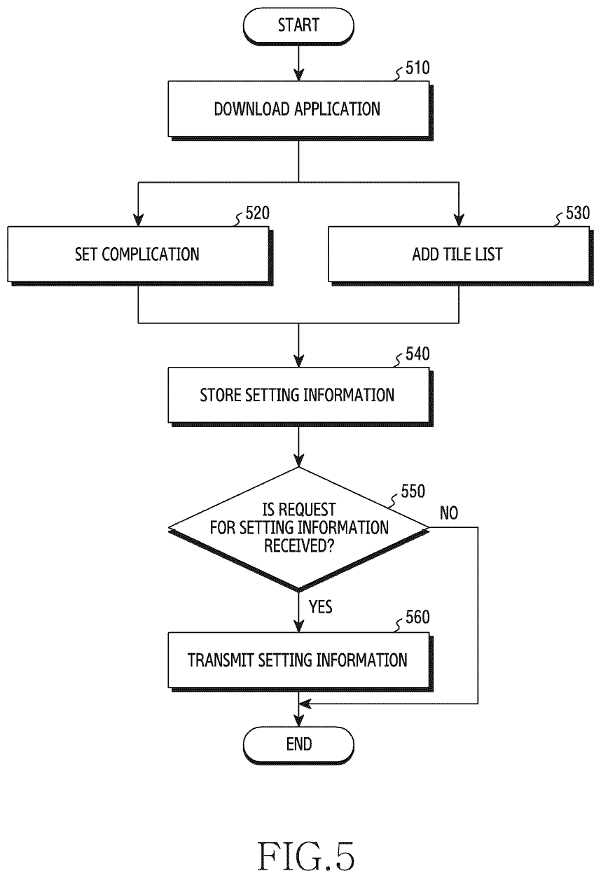

FIG. 5 is a view provided to explain a method for processing setting information of an object related to an application according to an embodiment.

Referring to FIG. 5, in operation 510, a processor (for example, the processor 271 of FIG. 2) of an external electronic device (for example, the electronic device 201 of FIG. 2) may download an application. The processor may download the application from an external server (for example, the server 108 of FIG. 1) connected via at least a communication circuit (for example, the communication circuit 231 of FIG. 2) and/or an electronic device (for example, the electronic device 101 of FIG. 1).

In operation 520, the processor may set the downloaded new application as a complication. For example, the processor may set the application as a complication to be displayed in a designated area of a watch screen, based on a user input.

In operation 530, the processor may add the downloaded new application to a tile list. For example, the processor may set the application as a tile that is configured separately from the watch screen, based on a user input. According to an embodiment, any one of operations 520 and 530 or both operations may be performed. Operations 520 and 530 may be performed separately or in parallel.

In operation 540, the processor may store setting information of the complication and/or setting information of the tile list in a memory (for example, the memory 251 of FIG. 2).

In operation 550, the processor may determine whether a request for the setting information is received from the electronic device (for example, the electronic device 101 of FIG. 1) connected via the communication circuit.

When the request for the setting information is not received (No in operation 550), the processor may finish the process of processing the setting information of an object related to the application.

When the request for the setting information is received (Yes in operation 550), the processor may transmit the setting information to the external electronic device via the communication circuit in operation 560. The external electronic device which receives the setting information may display an object that recommends a setting of a screen to be displayed on the display of the external electronic device, based on the setting information.

As described above, according to various embodiments, a method for recommending a setting of a screen in the electronic device 200 may include: acquiring setting information related to at least one first screen of an external electronic device (310); identifying at least one second object corresponding to at least one first object constituting the at least one first screen from the memory 250, based on the setting information (330); and recommending a setting of a second screen displayed on the display 210 by using the at least one second object (350).

According to various embodiments, the setting information may include at least one of history information of a watch screen displayed on the at least one first screen, object information related to an application displayed on the at least one first screen, or color information used for the at least one first screen.

According to various embodiments, identifying the at least one second object may include determining at least one first watch screen as the first object, based on the history information of the watch screen, and acquiring at least one second watch screen corresponding to the at least one first watch screen from the memory as the second object.

According to various embodiments, recommending the setting of the second screen may include recommending the at least one second watch screen for the second screen.

According to various embodiments, the method may further include determining a display order of the at least one second watch screen within a list, based on at least one of the number of times or frequency that the at least one first watch screen is used, or an order in which the at least one first watch screen is disposed in a list including a plurality of watch screens.

According to various embodiments, identifying the at least one second object may include determining at least one first application, based on the object information related to the application, and identifying at least one second application installed in the electronic device and corresponding to the at least one first application as the second object.

According to various embodiments, recommending the setting of the second screen may include displaying an object related to the at least one second application on the second screen.

According to various embodiments, the method may further include determining a display order of the object related to the at least one second application within a list, based on at least one of a type of an object related to the at least one first application, a proportion of the at least one first screen occupied by the object, or the number of times or frequency that the object is used.

According to various embodiments, recommending the setting of the second screen may include determining at least one color based on the color information, and displaying a color list including the at least one color on the second screen.

According to various embodiments, the method may further include determining a display order of the at least one color in a list, based on the number of times or frequency that the at least one color is used.

According to various embodiments, the at least one first screen may include at least one of a watch screen including a complication or a tile including a widget of an application.

According to various embodiments, the electronic device may further include: a housing including a first part and a second part; a flexible display seated on, directly or indirectly, a first surface of the first part and a second surface of the second part; and a hinge structure which pivots the first part or the second part to go into a first state in which the first surface and the second surface are substantially coplanar, or a second state in which the first surface and the second surface face each other.

According to various embodiments, the second screen may be displayed on the display that is disposed on a third surface of the first part opposite to the first surface.

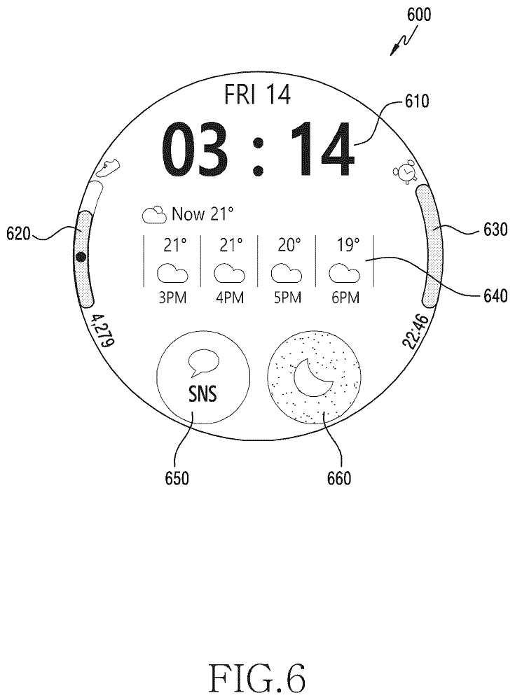

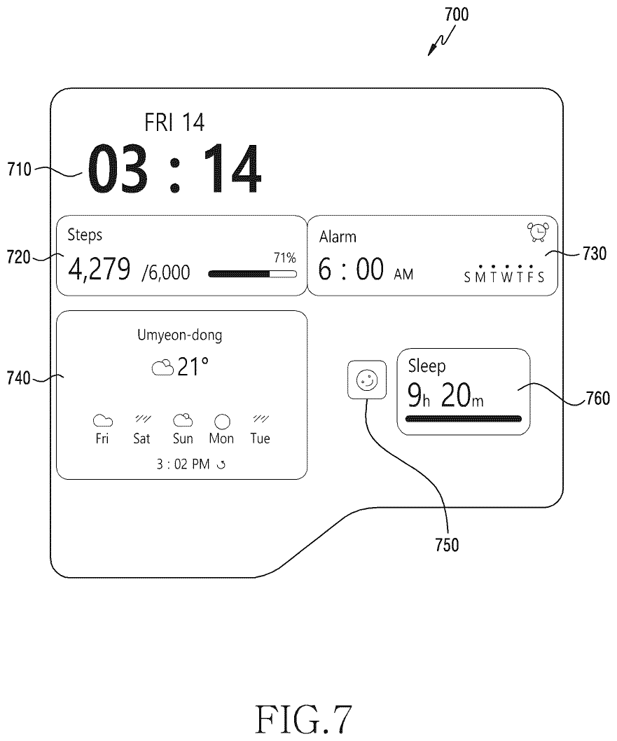

FIG. 6 is a view provided to explain a screen related to setting information acquired from an external electronic device according to an embodiment, and FIG. 7 is a view provided to explain a screen recommended in an electronic device according to an embodiment.

Referring to FIGS. 6 and 7, a processor (for example, the processor 270 of FIG. 2) of an electronic device (for example, the electronic device 200 of FIG. 2) may acquire setting information related to at least one first screen 600 of an external electronic device from the external electronic device connected via a communication circuit (for example, the communication circuit 230 of FIG. 2). According to an embodiment, the at least one first screen 600 may include a screen of a wearable electronic device (for example, a smart watch). According to an embodiment, the at least one first screen 600 may include at least one of a watch screen 610 including a complication 620, 630, 640, 650, 660 or a tile including a widget of an application. The complication 620, 630, 640, 650, 660 may be an additional information element displayed on the watch screen 610, and may be an object (for example, an icon, a visual object, an image, a widget, or an affordance) that executes at least one function of an application. The complication 620, 630, 640, 650, 660 may include, for example, at least one of a first complication 620 displaying the number of steps, a second complication 630 providing an alarm function, a third complication 640 displaying weather, a fourth complication 650 providing a SNS function, or a fifth complication 660 providing sleep information. According to an embodiment, the complication 620, 630, 640, 650, 660 may be displayed in a designated area of the watch screen 610. For example, the first complication 620, the second complication 630, the third complications 640, the fourth complications 650 or the fifth complications 660 may be displayed on one of a left edge area, a right edge area, a center area, a left lower end area or a right lower end area of the watch screen 610. Although not shown, the tile may include an execution screen of the widget of the application. Like pages, a plurality of tiles may be included, and each tile may constitute one screen. In this case, based on a user input (for example, a swipe input), transition between tiles, for example, screen transition from a first tile to a second tile, may be performed.

The processor may identify a second object corresponding to at least one first object (for example, the watch screen 610, the first complication 620, the second complication 630, the third complication 640, the fourth complication 650 or the fifth complication 660) constituting the at least one first screen from a memory (for example, the memory 250 of FIG. 2), based on the setting information. The at least one second object may be an object installed (or stored) in the electronic device, and may include at least one of a watch screen 710 or widgets 720, 730, 740, 750, 760 of applications.

The processor may recommend a setting of a second screen 700 displayed on a display (for example, the display 210 of FIG. 2) by using the at least one second object 710, 720, 730, 740, 750, 760. The second screen 700 may be a screen displayed on the display. According to an embodiment, the electronic device may be a foldable electronic device. When the electronic device is a foldable electronic device, the second screen 700 may be a screen displayed on a cover display.

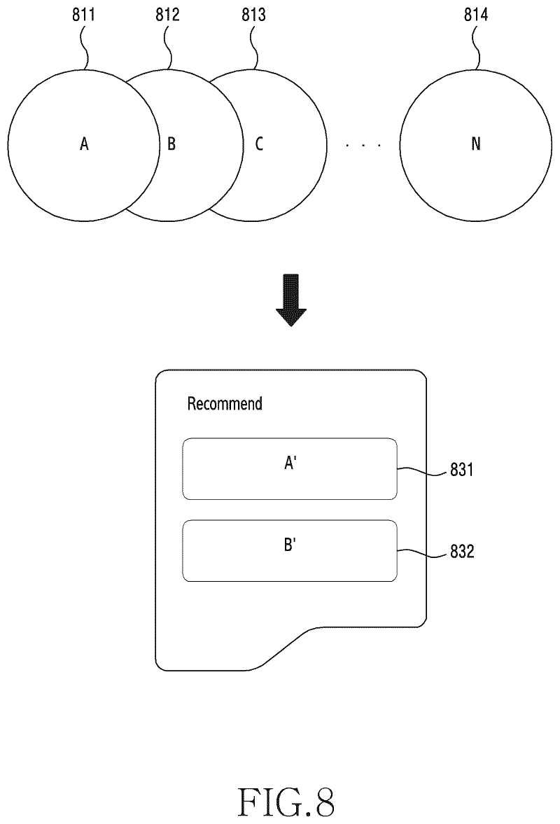

FIG. 8 is a view provided to explain a method for recommending a setting of a screen based on a watch screen list according to an embodiment.

Referring to FIG. 8, a processor (for example, the processor 270 of FIG. 2) of an electronic device (for example, the electronic device 200 of FIG. 2) may acquire setting information related to at least one first screen of an external electronic device from the external electronic device connected via a communication circuit (for example, the communication circuit 230 of FIG. 2). According to an embodiment, the at least one first screen may include at least one of a watch screen including a complication or a tile including a widget of an application.

The processor may identify at least one second object corresponding to at least one first object constituting the at least one first screen from a memory (for example, the memory 250 of FIG. 2), based on the setting information. The at least one first object may be an object that is installed (or stored) in the external electronic device, and may include at least one of a watch screen, a complication included in the watch screen, a tile or a widget included in the tile. The at least one second object may be an object that is installed (or stored) in the electronic device, and may include at least one of a watch screen or a widget of an application.

The processor may recommend a setting of a second screen displayed on a display (for example, the display 210 of FIG. 2) by using the at least one second object. According to an embodiment, the processor may determine at least one first watch screen as the first object, based on history information of the displayed watch screen, may acquire at least one second watch screen corresponding to the at least one first watch screen from the memory as the second object, and may recommend the at least one second watch screen for the second screen. The history information of the displayed watch screen may include, for example, at least one of the number of times or frequency that the at least one first watch screen is used, or an order (or an arrangement order) in which the at least one first watch screen is disposed in a list including a plurality of watch screens (for example, a watchface list). For example, the processor may determine a watch screen that is much used or frequently used and/or a watch screen that is disposed at the front of the list including the plurality of watch screens as the at least one first watch screen. FIG. 8 illustrates that watch screens 811, 812 disposed at the front of the list including the plurality of watch screens 811, 812, 813, 814 are determined as the at least one first watch screen. Thereafter, the processor may acquire watch screens 831, 832 corresponding to the at least one determined first watch screens 811, 812 from the memory, and may recommend the watch screens 831, 832 acquired from the memory for the at least one second watch screen.

According to an embodiment, the processor may determine a display order of the at least one second watch screen in the list, based on the history information of the displayed watch screen. For example, the processor may determine the display order of the at least one second watch screen, based on at least one of the number of times or frequency that the at least one first watch screen is used, or the order (or arrangement order) in which the at least one first watch screen is disposed in the list including the plurality of watch screens. According to an embodiment, the processor may set a high priority to a watch screen that is much used or frequently used and/or a watch screen that is disposed at the front of the list including the plurality of watch screens, and may display the watch screens. For example, as shown in FIG. 8, the processor may display a watch screen that is much used or frequently used and/or a watch screen 831, 832 that is disposed at the front in the list including the plurality of watch screens at a high position of the second screen.

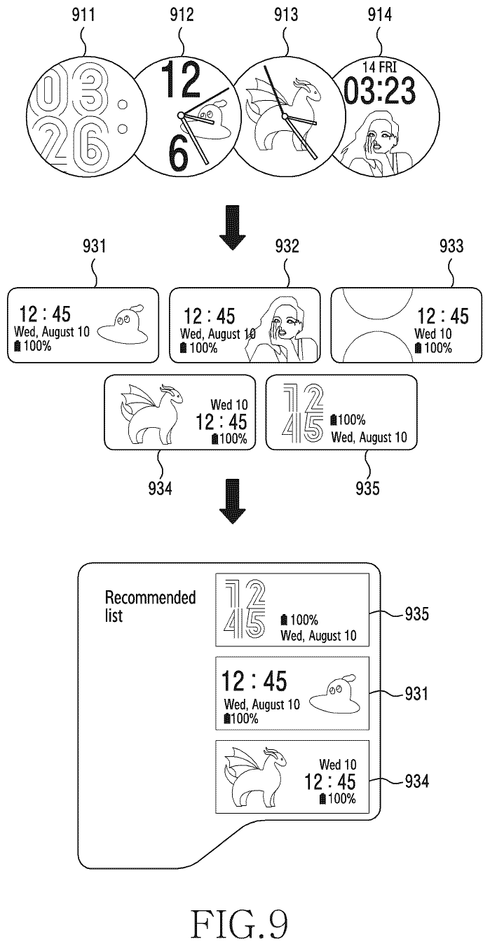

FIG. 9 is a view provided to explain a method for recommending a setting of a screen based on a watch screen list according to an embodiment.

Referring to FIG. 9, a processor (for example, the processor 270 of FIG. 2) of an electronic device (for example, the electronic device 200 of FIG. 2) may acquire setting information related to at least one first screen of an external electronic device from the external electronic device connected via at least a communication circuit (for example, the communication circuit 230 of FIG. 2). According to an embodiment, the at least one first screen may include at least one of a watch screen including a complication or a tile including a widget of an application.

The processor may identify at least one second object corresponding to at least one first object constituting the at least one first screen from a memory (for example, the memory 250 of FIG. 2), based on the setting information. The at least one first object may be an object that is installed (or stored) in the external electronic device, and may include at least one of a watch screen, a complication included in the watch screen, a tile or a widget included in the tile. The at least one second object may be an object that is installed (or stored) in the electronic device, and may include at least one of a watch screen or a widget of an application.

The processor may recommend a setting of a second screen displayed on a display (for example, the display 210 of FIG. 2) by using the at least one second object. According to an embodiment, the processor may determine a first watch screen as the at least one first object, based on history information of the displayed watch screen, may acquire at least one second watch screen corresponding to the at least one first watch screen from the memory as the second object, and may recommend the at least one second watch screen for the second screen. The history information of the displayed watch screen may include, for example, at least one of the number of times or frequency that the at least one first watch screen is used, or an order (or an arrangement order) in which the at least one first watch screen is disposed in a list including a plurality of watch screens (for example, a watchface list). For example, the processor may determine a watch screen that is much used or frequently used and/or a watch screen that is disposed at the front of the list including the plurality of watch screens as the at least one first watch screen. FIG. 9 illustrates that watch screens 911, 912, 913 disposed at the front of the list including the plurality of watch screens 911, 912, 913, 914 are determined as the at least one first watch screen. Thereafter, the processor may acquire watch screens 935, 931, 934 corresponding to the at least one determined first watch screens 911, 912, 913 from the memory, and may recommend the watch screens 935, 931, 934 acquired from the memory for the at least one second watch screen. According to an embodiment, in the process of acquiring the watch screen corresponding to the at least one first watch screen 911, 912, 913 from the memory, a configuration similarity of the watch screens may be considered. The configuration similarity may be assessed based on at least one of a background pattern, a texture, a character, a watch type (for example, digital or analogue), an amount of information provided except for time. When the watch screen corresponding to the at least one first watch screen 911, 912, 913 is not found from the memory (or is not acquired), the processor may display, on the display, a user interface to generate a watch screen similar to the configuration of the at least one first watch screen 911, 912, 913, or to download a watch screen having a high configuration similarity to the at least one first watch screen 911, 912, 913 from an external server.

According to an embodiment, the processor may determine a display order of the at least one second watch screen, based on the history information of the displayed watch screen. For example, the processor may determine the display order of the at least one second watch screen, based on at least one of the number of times or frequency that the at least one first watch screen is used, or the order (or arrangement order) in which the at least one first watch screen is disposed in the list including the plurality of watch screens. According to an embodiment, the processor may set a high priority to a watch screen that is much used or frequently used and/or a watch screen that is disposed at the front of the list including the plurality of watch screens, and may display the watch screens. For example, as shown in FIG. 9, the processor may display a watch screen 935, 931, 934 that is much used or frequently used and/or a watch screen 911, 912, 913 that is disposed at the front in the list including the plurality of watch screens at a high position of the second screen.

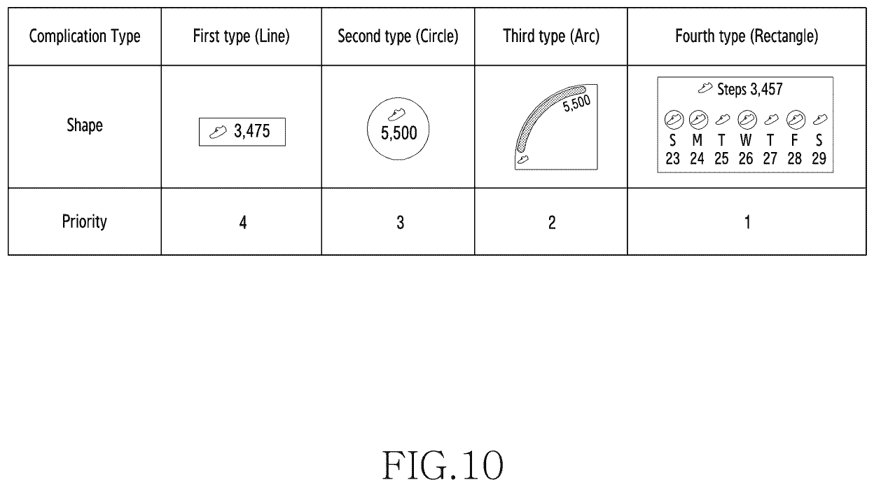

FIG. 10 is a view provided to explain a method for setting a priority according to a type of an object related to an application according to an embodiment.

Referring to FIG. 10, a processor (for example, the processor 270 of FIG. 2) of an electronic device (for example, the electronic device 200 of FIG. 2) may acquire setting information related to at least one first screen of an external electronic device from the external electronic device connected via a communication circuit (for example, the communication circuit 230 of FIG. 2). According to an embodiment, the at least one first screen may include at least one of a watch screen including a complication or a tile including a widget of an application.

The processor may identify at least one second object corresponding to at least one first object constituting the at least one first screen from a memory (for example, the memory 250 of FIG. 2), based on the setting information. The at least one first object may be an object that is installed (or stored) in the external electronic device, and may include at least one of a watch screen, a complication included in the watch screen, a tile or a widget included in the tile. The at least one second object may be an object that is installed (or stored) in the electronic device, and may include at least one of a watch screen or a widget of an application.

The processor may recommend a setting of a second screen displayed on a display (for example, the display 210 of FIG. 2) by using the at least one second object. According to an embodiment, the processor may determine at least one first application, based on object information related to an application, may identify at least one second application installed in the electronic device and corresponding to the at least one first application, and may display an object related to the at least one second application on the second screen. For example, the processor may determine an application that is set as a complication and/or an application that is added to a tile list as the at least one first application. In addition, the processor may identify whether an application corresponding to the at least one determined first application is installed in the electronic device, and may determine the identified application as the at least one second application.

According to an embodiment, the processor may determine a display order of an object related to the at least one second application, based on at least one of a type of an object related to the at least one first application, a proportion of the at least one first screen occupied by the object, or the number of times or frequency that the object is used. The type of the object may include, for example, a type of the complication. As shown in FIG. 10, the type of the complication may include a line shape, a circle shape, an arc shape, or a rectangle shape. The complication may have different amounts of information displayed on the screen according to the type. For example, the complication of the rectangle shape may include more amounts of information than the complication of the line shape. According to an embodiment, the processor may set a higher priority to the type of the complication that displays more information. For example, the processor may display an object at a high position of the second screen as the type of the object displays more information on the screen or the object is much used or frequently used.

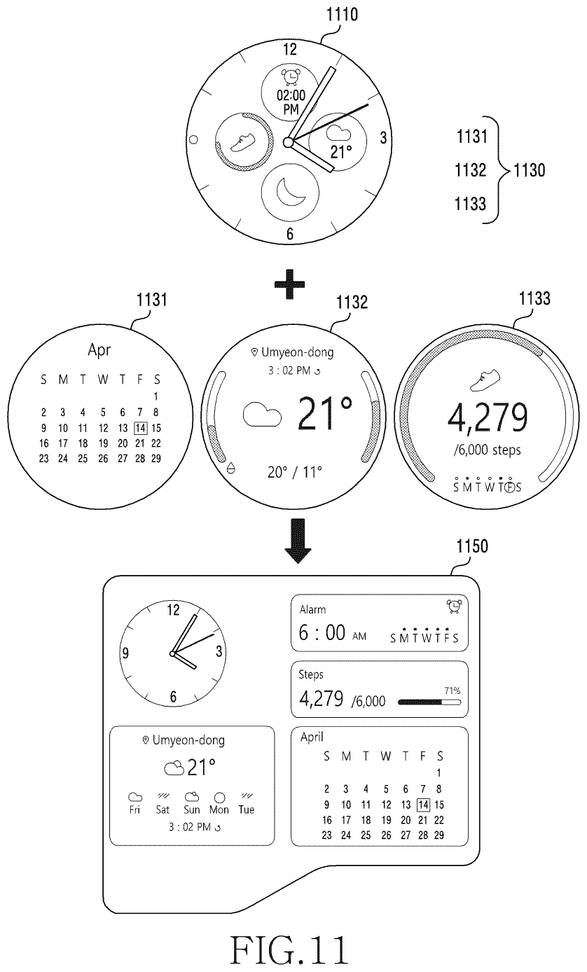

FIG. 11 is a view provided to explain a method for recommending a setting of a screen, based on setting information of a watch screen and setting information of an object related to an application according to an embodiment.

Referring to FIG. 11, a processor (for example, the processor 270 of FIG. 2) of an electronic device (for example, the electronic device 200 of FIG. 2) may acquire setting information related to at least one first screen of an external electronic device from the external electronic device connected via a communication circuit (for example, the communication circuit 230 of FIG. 2). According to an embodiment, the at least one first screen may include at least one of a watch screen 1110 including a complication or a tile 1130 including a widget of an application. The complication may be an additional information element that is displayed on the watch screen 1110, and may be an object (for example, an icon, a visual object, an image, a widget or an affordance) that executes at least one function of an application. The complication may provide, for example, information such as the number of steps, an alarm, weather, a SNS, or sleep. According to an embodiment, the complication may be displayed in a designated area of the watch screen. The tile 1130 may include an execution screen of a widget of an application. For example, the tile 1130 may include at least one of a calendar tile 1131, a weather tile 1132, or a number of steps tile 1133. The tile 1130 may include a plurality of tiles like pages, and each tile may constitute one screen. In this case, based on a user input (for example, a swipe input), transition between tiles, for example, screen transition from a first tile (for example, the calendar tile 1131) to a second tile (for example, the weather tile 1132), may be performed.

The processor may identify at least one second object corresponding to at least one first object constituting the at least one first screen from a memory (for example, the memory 250 of FIG. 2), based on the setting information. In addition, the processor may recommend a setting of a second screen 1150 displayed on a display (for example, the display 210 of FIG. 2) by using the at least one second object.

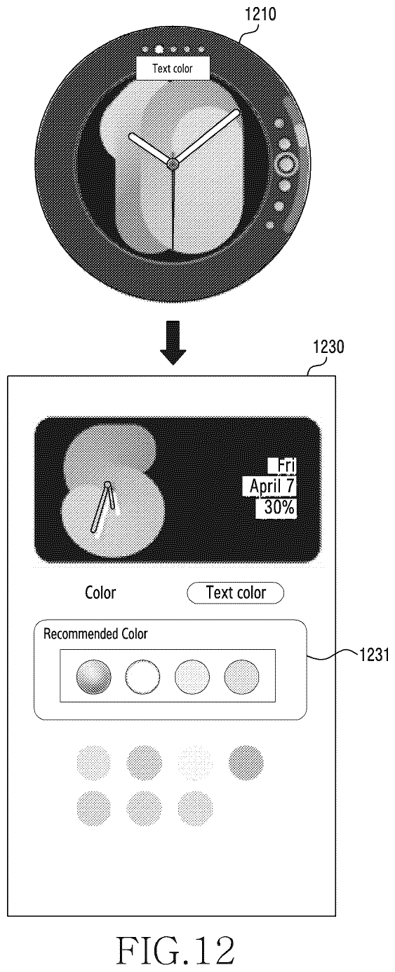

FIG. 12 is a view provided to explain a method for recommending a setting of a screen based on color information according to an embodiment.

Referring to FIG. 12, a processor (for example, the processor 270 of FIG. 2) of an electronic device (for example, the electronic device 200 of FIG. 2) may acquire setting information related to at least one first screen of an external electronic device from the external electronic device connected via a communication circuit (for example, the communication circuit 230 of FIG. 2). According to an embodiment, the at least one first screen may include at least one of a watch screen including a complication or a tile including a widget of an application.

The processor may acquire color information based on the setting information. For example, the processor may acquire color information that is used for a watch screen 1210 of the external electronic device.

The processor may determine at least one color based on the color information, and may display a color list 1231 including the at least one color on a second screen 1230. According to an embodiment, the processor may determine a display order of the at least one color, based on the number of times or frequency that the at least one color is used. For example, the processor may calculate a recommendation weight of a color, based on the frequency that the color used for the watch screen 1210 of the external electronic device is used, the number of watch screens used in the external electronic device. The recommendation weight of the color may be calculated based on the number of elements applying the corresponding color and the number of elements to which the color is applicable. Thereafter, the processor may recommend a color having the high recommendation weight when setting options related to colors in the electronic device. For example, the processor may determine at least one color, based on the color information, and may display the color list 1231 including the at least one color on the second screen 1230, and may display the color having the high recommendation weight of the color at a high position of the second screen 1230.

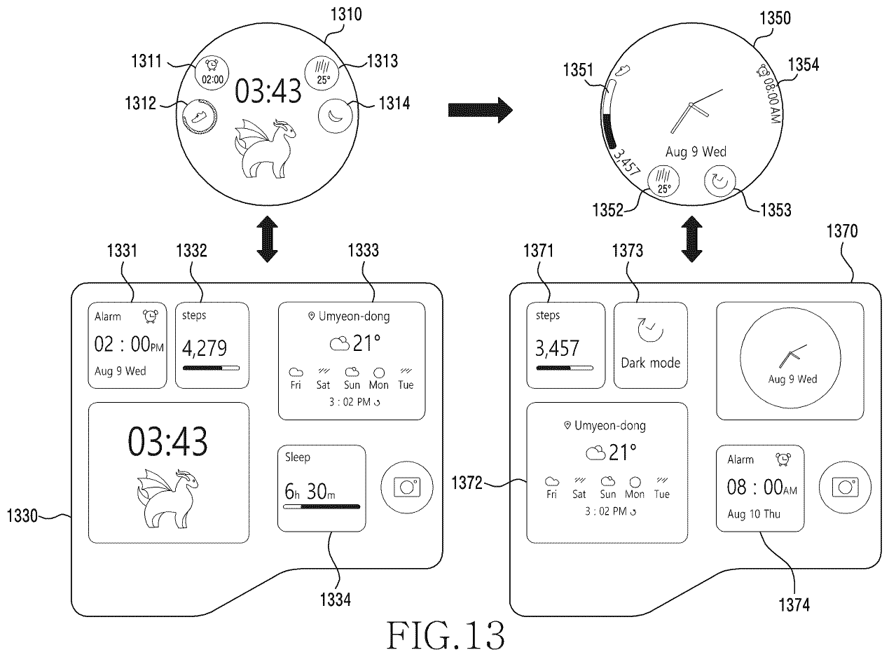

FIG. 13 is a view provided to explain an example of change from a second screen displayed on an electronic device to another second screen when a first screen displayed on an external electronic device is changed to another first screen according to an embodiment.

Referring to FIG. 13, a first screen 1310 (for example, a watch screen or a watchface screen) may be displayed on an external electronic device (for example, the external electronic device 201 of FIG. 2), and a second screen 1330 (for example, a widget group screen) that is determined at least based on complications 1311, 1312, 1313, 1314 within the first screen 1310 may be displayed on an electronic device (for example, the electronic device 200 of FIG. 2).

For example, the complications 1311, 1312, 1313, 1314 within the first screen 1310 may include a complication 1311 of an alarm application, a complication 1312 of an application providing the number of steps, a complication 1313 of a weather application, and a complication 1314 of an application for sleep management.

The second screen 1330 may be a screen corresponding to the first screen 1310. For example, the second screen 1330 may be a screen that has a similar theme and/or color to the first screen 1310. For example, the second screen 1330 may include widgets 1331, 1332, 1333, 1334 corresponding to the complications 1311, 1312, 1313, 1314 within the first screen 1310, respectively. For example, the application providing the complications 1311, 1312, 1313, 1314 within the first screen 1310 may be the same as the application providing the widgets 1331, 1332, 1333, 1334 within the second screen 1330. For example, the widgets 1331, 1332, 1333, 1334 within the second screen 1330 may include a widget 1331 of the alarm application, a widget 1332 of the application providing the number of steps, a widget 1333 of the weather application, and a widget 1334 of the application for sleep management. In addition, the second screen may include a watch screen or a watch widget including a current time.

Thereafter, the first screen 1310 displayed on the external electronic device may be changed to another first screen 1350. The other first screen 1350 may include other complications 1351, 1352, 1353, 1354 which are different from the complications 1311, 1312, 1313, 1314 within the first screen 1310. The other complications 1351, 1352, 1353, 1354 may be different from the complications 1311, 1312, 1313, 1314 in at least one of the shape, display position, color or information. For example, the other complications 1351, 1352, 1353, 1354 may include a complication 1351 of an application providing the number of steps, a complication 1352 of a weather application, a complication 1353 of an application for mode/routine management, and a complication 1354 of an alarm application.

When the first screen 1310 displayed on the external electronic device is changed to the other first screen 1350, the external electronic device may notify the electronic device of the change of the first screen 1310. In this case, for example, the external electronic device may provide information informing that the first screen 1310 is changed and setting information of the other first screen 1350 to the electronic device.

The electronic device which receives the change of the first screen 1310 from the external electronic device may change the second screen 1330 displayed on the electronic device to another second screen 1370 as the first screen 1310 displayed on the external electronic device is changed to the other first screen 1350.

In this case, the electronic device which receives the notification of the screen change may display a GUI inquiring whether to change the second screen 1330 of the electronic device. For example, the GUI may be displayed via a separate pop-up window. In this case, the electronic device may change the second screen 1330 to the other second screen 1370 based on a user input through the GUI.

Alternatively, for example, the electronic device which receives the notification of the screen change may automatically change the second screen 1330 to the other second screen 1370 without displaying the GUI inquiring whether to change the second screen 1330 of the electronic device. When the second screen 1330 is automatically changed to the other second screen 1370 without a user input, information informing that the second screen 1330 is changed may be outputted through the electronic device.

According to an embodiment, the other second screen 1370 may be determined at least based on the other complications 1351, 1352, 1353, 1354 within the other first screen 1350. The other second screen 1370 may be a screen corresponding to the other first screen 1350. For example, the other second screen 1370 may be a screen that has a similar theme and/or color to the other first screen 1350. For example, the other second screen 1370 may include other widgets 1371, 1372, 1374, 1374 corresponding to the complications 1351, 1352, 1353, 1354 within the other first screen 1350, respectively. For example, the other widgets 1371, 1372, 1373, 1374 may include a widget 1371 of the application providing the number of steps, a widget 1372 of the weather application, a widget 1373 of the application for mode/routine management, and a widget 1374 of the alarm application.

According to an embodiment, the shapes and sizes of the widgets 1331, 1332, 1333, 1334 within the second screen 1330, and the other widgets 1371, 1372, 1373, 1374 within the other second screen may be determined according to importance of the widgets and information to be displayed through the widgets. For example, when the importance of a widget is high or there is much information to be displayed through a widget, the widget may be set to have a large size.

According to an embodiment, the sizes of the widgets 1331, 1332, 1333, 1334 within the second screen 1330, and the other widgets 1371, 1372, 1373, 1374 within the other second screen may be determined according to sizes of corresponding complications. When the size of a complication is large, the corresponding widget may be set to have a large size.

According to an embodiment, the positions of the widgets 1331, 1332, 1333, 1334 within the second screen 1330, and the other widgets 1371, 1372, 1373, 1374 within the other second screen may be determined according to positions of complications displayed on the external electronic device. The corresponding widgets may be set to be disposed at similar positions to the positions of the complications displayed on the external electronic device.

According to an embodiment, when a widget corresponding to an application of a complication displayed on the external electronic device is not installed in the electronic device, the electronic device may include a widget of another similar application in the second screen 1330 and/or the other second screen 1370.

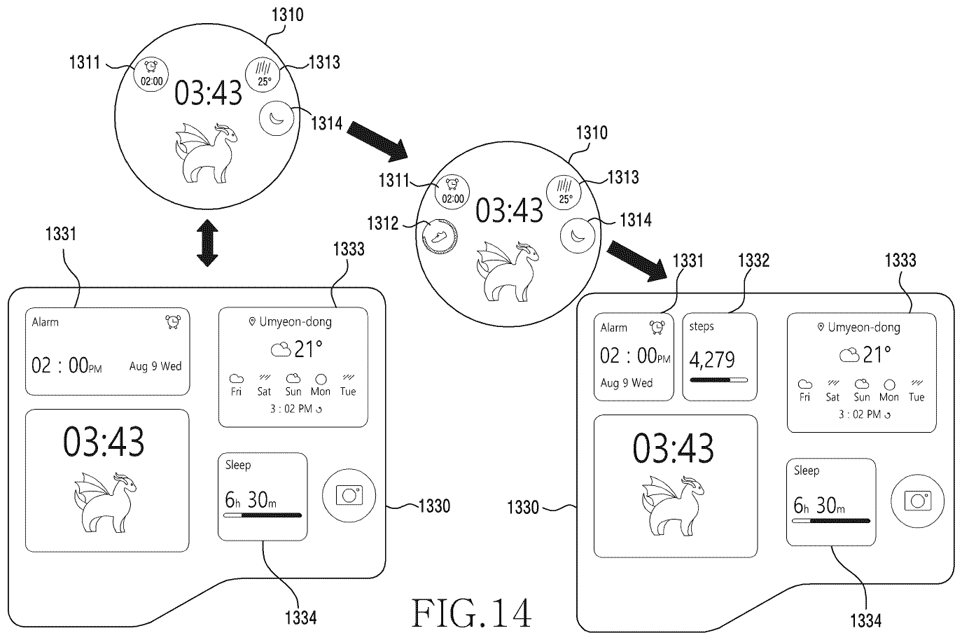

FIG. 14 is a view provided to explain an example of change of a configuration of a second screen displayed on an electronic device when a complication is added within a first screen displayed on an external electronic device according to an embodiment.

Referring to FIG. 14, a first screen 1310 (for example, a watch screen or a watchface screen) may be displayed on an external electronic device (for example, the external electronic device 201 of FIG. 2), and a second screen 1330 (for example, a widget group screen) that is determined at least based on complications 1311, 1313, 1314 within the first screen 1310 may be displayed on an electronic device (for example, the electronic device 200 of FIG. 2). For example, the complications 1311, 1313, 1314 within the first screen 1310 may include a complication 1311 of an alarm application, a complication 1313 of a weather application, and a complication 1314 of an application for sleep management.

The second screen 1330 may be a screen corresponding to the first screen 1310. For example, the second screen 1330 may be a screen that has a similar theme and/or color to the first screen 1310. For example, the second screen 1330 may include widgets 1331, 1333, 1334 corresponding to the complications 1311, 1313, 1314 within the first screen 1310, respectively. For example, the application providing the complications 1311, 1313, 1314 within the first screen 1310 may be the same as the application providing the widgets 1331, 1333, 1334 within the second screen 1330. For example, the widgets 1331, 1333, 1334 within the second screen 1330 may include a widget 1331 of the alarm application, a widget 1333 of the weather application, and a widget 1334 of the application for sleep management. The second screen may include, for example, a watch screen or a watch widget indicating a current time.

According to an embodiment, the first screen 1310 of the external electronic device and the second screen 1330 of the electronic device may be displayed in conjunction with each other.

Thereafter, the configuration of the first screen 1310 displayed on the external electronic device may be changed. The external electronic device may change the configuration of the first screen 1310, based on a user input on a screen setting application installed in the external electronic device. For example, the external electronic device may add or delete a complication to or from the first screen 1310, but this should not be considered as limiting.

For example, a complication 1312 of an application providing the number of steps may be added within the first screen 1310 displayed on the external electronic device. When the complication 1312 is added within the first screen 1310 displayed on the external electronic device, the external electronic device may notify the electronic device that the complication 1312 is added within the first screen 1310. In this case, for example, the external electronic device may provide the electronic device with information informing that the complication 1312 is added within the first screen 1310, an identification value of an application corresponding to the added complication 1312, and information on the added complication 1312.

According to an embodiment, when the configuration of the first screen 1310 is changed based on a user input on the screen setting application installed in the external electronic device, the external electronic device may transmit the information informing the change of the configuration of the first screen 1310 to the electronic device through the screen setting application. In addition, the information informing the change of the configuration of the first screen 1310 that is transmitted to the electronic device may be processed by an application for setting the screen of the electronic device.

According to an embodiment, the electronic device which receives the notification informing that the complication 1312 is added within the first screen 1310 from the external electronic device may add a widget 1332 of an application corresponding to the added complication 1312 displayed on the external electronic device within the second screen 1330. For example, the electronic device which receives the notification of the screen change may display a GUI inquiring whether to add the widget 1332 within the second screen 1330 of the electronic device. For example, the GUI may be displayed through a separate pop-up window. In this case, based on a user input through the displayed GUI, the electronic device may add the widget 1332 within the second screen 1330. Alternatively, the electronic device which receives the notification of the addition of the complication 1312 may automatically add the widget 1332 within the second screen 1330 without displaying the GUI inquiring whether to add the widget 1332 within the second screen 1330 of the electronic device. When the widget 1332 is automatically added within the second screen 1330 without a user input, information informing that the widget 1332 is added within the second screen 1330 may be outputted through the electronic device.

According to an embodiment, as the widget 1332 is added within the second screen 1330, the screen configuration of the second screen 1330 may be changed. For example, the size and position of at least one of the widgets 1331, 1333, 1334 within the second screen 1330 may be changed. For example, the widget 1331 may be reduced and the widget 1332 may be added close to the reduced widget 1331.

FIG. 14 illustrates that the configuration of the second screen 1330 of the electronic device is changed as the configuration of the first screen 1310 of the external electronic device is changed, but this should not be considered as limiting. For example, the configuration of the first screen 1310 of the external electronic device may be changed as the configuration of the second screen 1330 of the electronic device is changed.

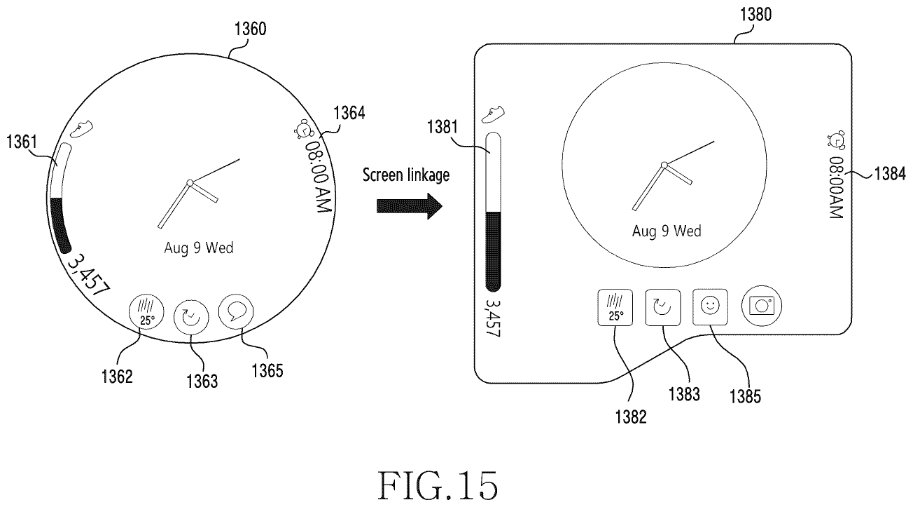

FIG. 15 is a view provided to explain an example of a second screen which is set to be visually similar to a first screen displayed on an external electronic device and is displayed on an electronic device according to an embodiment.

Referring to FIG. 15, a configuration of a first screen 1360 displayed on an external electronic device (for example, the external electronic device 201 of FIG. 2) and a configuration of a second screen 1380 of an electronic device (for example, the electronic device 200 of FIG. 2) may be set to be visually similar to each other.

For example, sizes, shapes, and/or positions of widgets 1381, 1382, 1383, 1384, 1385 within the second screen 1380, and sizes, shapes, and/or positions of complications 1361, 1362, 1363, 1364, 1365 within the first screen 1360 may be set to be similar to each other.

For example, with the first screen 1360 of the external electronic device, a complication 1361 of an application providing the number of steps may be disposed in a bent bar shape along a left edge portion of the first screen 1360, a complication 1362 of a weather application may be disposed in a circular shape (that is, a shape similar to the shape of the first screen 1360) on a left portion of the lower end of the first screen 1360, a complication 1363 of an application for mode/routine management may be disposed in a circular shape on a center portion of the lower end of the first screen 1360, a complication 1365 of a SNS application may be disposed in a circular shape on a right portion of the lower end of the first screen 1360, and a complication 1364 of an alarm application may be disposed along a right edge portion of the first screen 1360.

In addition, for example, within the second screen 1380 of the electronic device, a widget 1381 of the application providing the number of steps may be disposed in a bar shape along a left edge portion of the second screen 1380, a widget 1382 of the weather application may be disposed in a rectangular shape (that is, a shape similar to the shape of the second screen 1380) on a left portion of the lower end of the second screen 1380, a widget 1383 of the application for mode/routine management may be disposed in a rectangular shape on a center portion of the lower end of the second screen 1380, a widget 1385 of the SNS application may be disposed in a rectangular shape on a right portion of the lower end of the second screen 1380, and a widget 1384 of the alarm application may be disposed along a right edge portion of the second screen 1380.

In this case, the sizes and shapes of the widget 1381 of the application providing the number of steps, the widget 1382 of the weather application, the widget 1383 of the application for mode/routine management, the widget 1384 of the alarm application, and the widget 1385 of the SNS application may be determined according to the sizes and shapes of the corresponding complications 1361, 1362, 1363, 1364, 1365. For example, the widgets 1382, 1383, 1355 within the second screen 1380 corresponding to the complications 1362, 1363, 1365 of the small circular shape within the first screen 1360 may be set to minimum widget sizes (for example, 1×1).

According to an embodiment disclosed, the electronic device may include a display. The electronic device may include a communication circuit. The electronic device may include a memory configured to store instructions. The electronic device may include at least one processor including a processing circuit. The instructions may be executed individually or collectively by the at least one processor. The electronic device may acquire setting information related to at least one first screen of an external electronic device. The electronic device may identify at least one second object corresponding to at least one first object constituting the at least one first screen from the memory, based on the setting information. The electronic device may recommend a setting of a second screen displayed on the display by using the at least one second object.

According to an embodiment, the setting information may include at least one of history information of a watch screen displayed on the at least one first screen, object information related to an application displayed on the at least one first screen, or color information used for the at least one first screen.

According to an embodiment, the electronic device may determine at least one first watch screen as the first object, based on the history information of the watch screen. The electronic device may acquire at least one second watch screen corresponding to the at least one first watch screen from the memory as the second object. The electronic device may recommend the at least one second watch screen for the second screen.

According to an embodiment, the electronic device may determine a display order of the at least one second watch screen within a second list, based on at least one of the number of times or frequency that the at least one first watch screen is used, or an order in which the at least one first watch screen is disposed in a first list including a plurality of watch screens.

According to an embodiment, the electronic device may determine at least one first application as the first object, based on the object information related to the application. The electronic device may identify at least one second application corresponding to the at least one first application as the second object. The at least one second application may be installed in the electronic device. The electronic device may recommend an object related to the at least one second application for the second screen.

According to an embodiment, the electronic device may determine a display order of the object related to the at least one second application within a list, based on at least one of a type of an object related to the at least one first application, a proportion of the at least one first screen occupied by that the object related to the first application, or the number of times or frequency that the object related to the first application is used.

According to an embodiment, the electronic device may determine at least one color based on the color information. The electronic device may recommend a color list including the at least one color for the second screen.

According to an embodiment, the electronic device may determine a display order of the at least one color in a list, based on the number of times or frequency that the at least one color is used.

According to an embodiment, the at least one first screen may include at least one of a watch screen including a complication or a tile including a widget of an application.

According to an embodiment, the electronic device may include a housing including a first part and a second part. The electronic device may include a flexible display seated on a first surface of the first part and a second surface of the second part. The electronic device may include a hinge structure which pivots the first part or the second part to go into a first state in which the first surface and the second surface are substantially coplanar, or a second state in which the first surface and the second surface face each other. The second screen may be displayed on the display that is disposed on a third surface of the first part opposite to the first surface.

According to an embodiment, the first object may include at least one of a watch screen, a complication included in the watch screen, a tile, or a widget included in the tile, which constitute the first screen.

According to an embodiment, the second object may include at least one of a watch screen or a widget of an application which constitute the second screen.

According to an embodiment disclosed, a method for recommending a setting of a screen in an electronic device may include acquiring setting information related to at least one first screen of an external electronic device. The method for recommending the setting of the screen in the electronic device may include identifying at least one second object corresponding to at least one first object constituting the at least one first screen from a memory, based on the setting information. The method for recommending the setting of the screen in the electronic device may include recommending a setting of a second screen displayed on a display by using the at least one second object.

According to an embodiment, the first object may include at least one of a watch screen, a complication included in the watch screen, a tile, or a widget included in the tile, which constitute the first screen. The second object may include at least one of a watch screen or a widget of an application which constitute the second screen.

According to an embodiment, the setting information may include at least one of history information of a watch screen displayed on the at least one first screen, object information related to an application displayed on the at least one first screen, or color information used for the at least one first screen.

According an embodiment, identifying the at least one second object may include determining at least one first watch screen, based on the history information of the watch screen. Identifying the at least one second object may include acquiring at least one second watch screen corresponding to the at least one first watch screen from the memory. Recommending the setting of the second screen may include displaying the at least one second watch screen for the second screen.

According to an embodiment, the method for recommending the setting of the screen in the electronic device may include determining a display order of the at least one second watch screen, based on at least one of the number of times or frequency that the at least one first watch screen is used, or an order in which the at least one first watch screen is disposed in a list including a plurality of watch screens.

According an embodiment, identifying the at least one second object may include determining at least one first application, based on the object information related to the application. Identifying the at least one second object may include identifying at least one second application installed in the electronic device and corresponding to the at least one first application. Recommending the setting of the second screen may include displaying an object related to the at least one second application on the second screen.

According to an embodiment, the method for recommending the setting of the screen in the electronic device may include determining a display order of the object related to the at least one second application, based on at least one of a type of an object related to the at least one first application, a proportion of the at least one first screen occupied by the object, or the number of times or frequency that the object is used. “Based on” as used herein covers based at least on.

According to an embodiment, recommending the setting of the second screen may include determining at least one color based on the color information. Recommending the setting of the second screen may include displaying a color list including the at least one color on the second screen.

According to an embodiment, the method for recommending the setting of the screen in the electronic device may include determining a display order of the at least one color, based on the number of times or frequency that the at least one color is used.

According to an embodiment, the electronic device may include a housing including a first part and a second part. The electronic device may include a flexible display seated on a first surface of the first part and a second surface of the second part. The electronic device may include a hinge structure which pivots the first part or the second part to go into a first state in which the first surface and the second surface are substantially coplanar, or a second state in which the first surface and the second surface face each other. The second screen may be displayed on the display that is disposed on a third surface of the first part opposite to the first surface.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a communication circuit;
a memory configured to store instructions; and
at least one processor comprising a processing circuit,
wherein the instructions, when executed by the at least one processor individually and/or collectively, cause the electronic device to:
acquire setting information related to at least one first screen of an external electronic device;
identify at least one second object corresponding to at least one first object related to the at least one first screen from the memory, based on the setting information; and
recommend a setting of a second screen to be displayed on the display by using at least the at least one second object.

2. The electronic device of claim 1, wherein the setting information comprises at least one of: history information of a watch screen from the at least one first screen, object information related to an application from the at least one first screen, or color information from the at least one first screen.

3. The electronic device of claim 2,
wherein the instructions, when executed by the at least one processor individually and/or collectively, cause the electronic device to:
determine at least one first watch screen as the first object, based on the history information of the watch screen;
acquire at least one second watch screen corresponding to the at least one first watch screen from the memory as the second object; and
recommend the at least one second watch screen for the second screen.

4. The electronic device of claim 3,
wherein the instructions, when executed by the at least one processor individually and/or collectively, cause the electronic device to:
determine a display order of the at least one second watch screen within a second list, based on at least one of the number of times and/or frequency that the at least one first watch screen is used, and/or an order in which the at least one first watch screen is disposed in a first list comprising a plurality of watch screens.

5. The electronic device of claim 2,
wherein the instructions, when executed by the at least one processor individually and/or collectively, cause the electronic device to:
determine at least one first application as the first object, based on the object information related to the application;
identify at least one second application corresponding to the at least one first application as the second object, the at least one second application being installed in the electronic device; and
recommend an object related to the at least one second application for the second screen.

6. The electronic device of claim 5,
wherein the instructions, when executed by the at least one processor individually and/or collectively, cause the electronic device to:
determine a display order of the object related to the at least one second application within a list, based on at least one of: (i) a type of an object related to the at least one first application, (ii) a proportion of the at least one first screen occupied by the object related to the first application, or (iii) the number of times and/or frequency that the object related to the first application is used.

7. The electronic device of claim 2,
wherein the instructions, when executed by the at least one processor individually and/or collectively, cause the electronic device to:
determine at least one color based on the color information; and
recommend a color list comprising the at least one color for the second screen.

8. The electronic device of claim 7,
wherein the instructions, when executed by the at least one processor individually and/or collectively, cause the electronic device to:
determine a display order of the at least one color in a list, based on the number of times and/or frequency that the at least one color is used.

9. The electronic device of claim 1, wherein the at least one first screen comprises at least one of: a watch screen comprising a complication, or a tile comprising a widget of an application.

10. The electronic device of claim 1, further comprising:
a housing comprising a first part and a second part;
a flexible display on a first surface of the first part and a second surface of the second part; and
a hinge structure, comprising a hinge, configured to pivot the first part and/or the second part to go into a first state in which the first surface and the second surface are substantially coplanar, and/or a second state in which the first surface and the second surface face each other,
wherein the second screen is configured to be displayed on the display that is disposed on a third surface of the first part opposite to the first surface.

11. The electronic device of claim 1, wherein the first object comprises at least one of: a watch screen, a complication included in the watch screen, a tile, or a widget included in the tile, which constitute the first screen.

12. The electronic device of claim 1, wherein the second object comprises at least one of: a watch screen or a widget of an application which constitute the second screen.

13. A method for recommending a setting of a screen in an electronic device, the method comprising:
acquiring setting information related to at least one first screen of an external electronic device;
identifying at least one second object corresponding to at least one first object constituting the at least one first screen from a memory, based on the setting information; and
recommending a setting of a second screen displayed on a display by using the at least one second object.

14. The method of claim 13, wherein the first object comprises at least one of a watch screen, a complication included in the watch screen, a tile, or a widget included in the tile, which constitute the first screen, and
wherein the second object comprises at least one of a watch screen or a widget of an application which constitute the second screen.

15. A computer-readable recording medium having a program recorded thereon to execute a method for recommending a setting of a screen, the method comprising:
acquiring setting information related to at least one first screen of an external electronic device;
identifying at least one second object corresponding to at least one first object constituting the at least one first screen from a memory, based on the setting information; and
recommending a setting of a second screen displayed on a display by using the at least one second object.
